(19) United States
(12) Patent Application Publication
(10) Pub. No.: US 2005/0015578 A1
(43) Pub. Date: Jan. 20, 2005

(54) Two-bit branch prediction scheme using reduced memory size

(76) Inventors: Kimming So, Palo Alto, CA (US); BaoBinh Truong, San Jose, CA (US)

Correspondence Address: Christopher C. Winslade;McAndrews, Held & Malloy, LTD., 34th Floor, 500 West Madison St., Chicago, IL, 60661, US

(21) Appl. No.: 10/744,517

(22) Filed: Dec. 23, 2003

Related U.S. Application Data
(60) Provisional application No. 60/486,997, filed on Jul. 14, 2003.

(51) Int. Cl. G06F 9/00

(52) U.S. Cl. 712/240

(57) ABSTRACT

One or more methods and systems of reducing the size of memory used in implementing a predictive scheme for executing conditional branch instructions are presented. In one embodiment, a conditional branch instruction addresses a first bit array and a second bit array of a branch history table. The branch history table comprises a first bit array and a second bit array in which the second bit array contains a fraction of the number of entries of said first bit array. In one or more embodiments, the size of the branch history table is reduced by at least twenty five percent, resulting in a reduction of memory required for implementing the predictive scheme.

### RELATED APPLICATIONS/INCORPORATION BY REFERENCE

This application makes reference to and claims priority from U.S. Provisional Patent Application Ser. No. 60/486,997, entitled “Shared Two-Bit Branch Prediction”, filed on Jul. 14, 2003, the complete subject matter of which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

In a software program, conditional branch instructions comprise a significant percentage of all instructions performed by a control processor. Execution of a conditional branch instruction usually involves a number of steps. These steps involve decoding the branch instruction, evaluating the condition posed by the branch instruction, using the result of the evaluation to determine if the next instruction is either the next sequential instruction or the targeted instruction of the branch, and fetching the next instruction. For pipelined control processors, executing all the steps of a branch instruction may require a number of clock cycles. Hence, the overall performance degradation may be significant when there are a large number of branches executed.

A common method of improving performance is to employ a branch history table (BHT) or branch prediction buffer to predict if a branch is taken prior to evaluation of the conditions associated with the branch decision. A branch address is mapped to one of the entries of the BHT and the value associated with the entry predicts if the branch is taken or not. A typical BHT contains thousands of entries, of which each entry may contain a few bits. The number of bits determines the prediction scheme used. For example, there are two prediction states if one bit is used, while there are four prediction states when two bits are used. In the one-bit prediction scheme, an entry remembers the result of the last branch that mapped to a particular entry. When the entry is accessed again, the same result will be predicted. However, if the prediction is incorrect, the value stored in the entry will be corrected.

There are a number of advantages associated with prediction schemes employing more than one bit such as that predicted by a two-bit prediction scheme. For example, the prediction scheme is more accurate using two bits when two conditional branch instructions map to the same entry having the conditions that 1) one of the instructions is executed much more frequently than the other instruction, and 2) the instruction that is executed much more frequently usually results in one outcome of the possible outcomes.

In another instance, a two-bit prediction scheme yields marginal performance improvement when a single conditional branch instruction maps to an entry which almost always results in the same outcome. It is found that the performance of the two-bit scheme is only slightly better than that of the one-bit scheme in this instance; as a consequence, it may not be cost effective to employ twice the memory for implementing the BHT as compared to that of a one-bit prediction scheme. The benefits of an additional bit provided by a two-bit scheme contributes to performance when the actual results of a particular branch instruction is unstable. However, the improvement may not warrant the increase in memory required to implement a typical two-bit prediction scheme.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention provide for a method and system of reducing the size of memory by implementing a predictive scheme used in execution of conditional branch instructions.

In one embodiment, a method of predicting the next state of a conditional branch instruction involves sharing one or more indexed entries in a bit array of a branch history table (BHT) used in implementing a two-bit predictive scheme. Aspects of the present invention incorporates the use of the BHT to predict if a conditional branch instruction is taken or not taken. The BHT utilizes four states in which the next instruction comprises either a branch that is strongly taken, a branch that is taken, a branch that is not taken, and a branch that is strongly not taken.

In one embodiment, a method of predicting the next state of a conditional branch instruction comprises indexing a branch history table comprising a first bit array and a second bit array, in which the second bit array contains a fraction of the number of entries of the first bit array. The number of entries contained in the second bit array may be one-half, one-quarter, or one-eighth the number of entries contained in the first bit array.

In one embodiment, a method of predicting the next state of a conditional branch instruction is performed by mapping a second bit array using a subset of bits used for mapping a first bit array. In one embodiment, the number of bits used for mapping the first bit array exceeds the subset of bits used for mapping the second bit array by one. In one embodiment, the number of bits used for mapping the first bit array exceeds the subset of bits used for mapping the second bit array by two. In yet another embodiment, the number of bits used for mapping the first bit array exceeds the subset of bits used for mapping the second bit array by three.

In yet another embodiment, a system for predicting the next state of a conditional branch instruction is composed of a bit array containing a fraction of a number of entries contained in one or more bit arrays.

In one embodiment, a system for predicting the next state of a conditional branch instruction is composed of a first bit array containing a number of entries and a second bit array containing a fraction of the number of entries. In one embodiment, the fraction of the number of entries is equal to one half of the number of entries. In one embodiment, the fraction of the number of entries is equal to one quarter of the number of entries. In yet another embodiment, the fraction of the number of entries is equal to one eighth of the number of entries.

These and other advantages, aspects, and novel features of the present invention, as well as details of illustrated embodiments, thereof, will be more fully understood from the following description and drawings.

### BRIEF DESCRIPTION OF THE DRAWINGS

FIG. 1A illustrates the transitional states associated with an exemplary one bit predictive scheme.

FIG. 1B illustrates the transitional states associated with an exemplary two-bit predictive scheme.

FIG. 2A illustrates a relational block diagram of an address of a conditional branch instruction being mapped to a one-bit branch history table (BHT) in accordance with an embodiment of the invention.

FIG. 2B illustrates a relational block diagram of an address of a conditional branch instruction being mapped to a two-bit branch history table (BHT) in accordance with an embodiment of the invention.

FIG. 3 illustrates a relational block diagram of an n′ entry BHT comprising two bit arrays of which the second bit array is one half the size of the first bit array in accordance with an embodiment of the invention.

### DETAILED DESCRIPTION OF THE INVENTION

Aspects of the present invention may be found in a method and system to implement a branch prediction scheme used when a branch instruction such as a conditional branch instruction is executed in a software program. A two-bit prediction scheme is presented that utilizes less memory space than that required in a typical two-bit prediction scheme. The two-bit prediction scheme employs a reduction of memory space by utilizing a fraction of a number of entries implemented in a first bit array to implement a second bit array in such a two-bit prediction scheme. Aspects of the invention provides for a system that uses a fraction of memory space previously used for addressing entries in a branch history table of a typical two-bit prediction scheme. In one embodiment, the system employs half the number of entries typically used to address a second bit array of a two-bit prediction scheme. In another embodiment, the system may employ one quarter (25%) of the number of entries typically used to address the second bit of a two-bit prediction scheme. Yet, in one embodiment, the system may employ one eighth (12.5%) of the number of entries typically used to address the second bit of a two-bit prediction scheme. As a result of the decreased number of addressable entries, the memory size required to implement a two-bit branch history table is reduced.

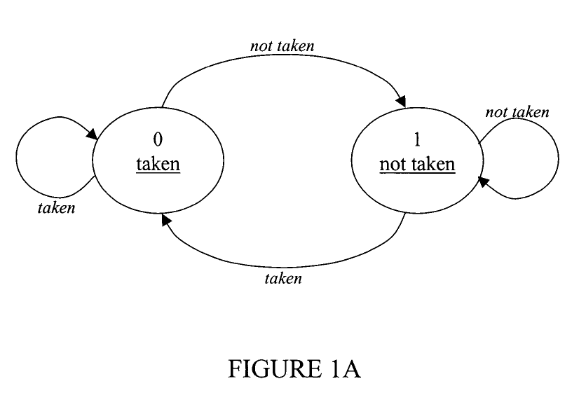

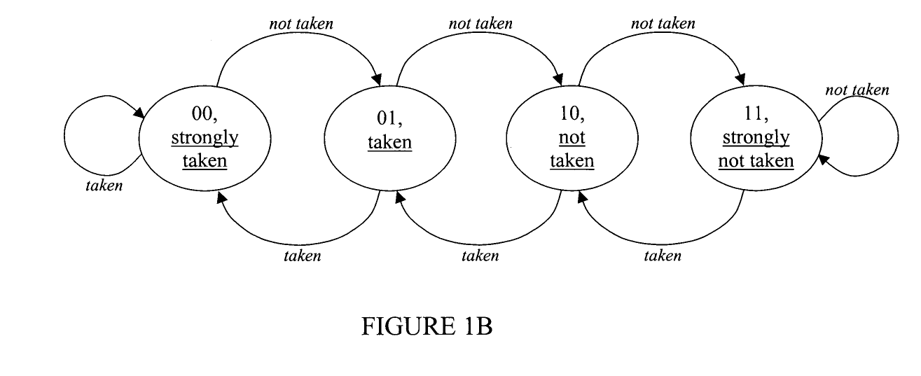

FIG. 1A illustrates a state transition diagram associated with an exemplary one-bit predictive scheme. There are two prediction states associated with this one-bit scheme—the first state corresponds to the state in which a branch is either “taken” while the second state corresponds to the state in which a branch is “not taken”. Given that the initial predicted state is 0 (taken), a transition occurs from state 0 (taken) to state 1 (not taken) when the actual result of a conditional branch instruction corresponds to “not taken”. In FIG. 1A, a transition is characterized by the occurrence of an actual state and is denoted by the arrows going from one state to another state while the two prediction states are indicated by circles. (In reference to FIG. 1A, the actual states are denoted in italics while the two prediction states are underlined.)

FIG. 1B illustrates a state transition diagram associated with an exemplary two-bit predictive scheme. As illustrated in the following Table 1, there are four prediction states associated with this two-bit predictive scheme.

TABLE 1

| Bit 1 | Bit 2 | Prediction State |
|---|---|---|
| 0 | 0 | Branch Strongly Taken |
| 0 | 1 | Branch Taken |
| 1 | 0 | Branch Not Taken |
| 1 | 1 | Branch Strongly Not Taken |

As shown in FIG. 1B, the prediction states vary based on the actual results or outcome of a decision executed in a conditional branch instruction. In reference to FIG. 1B, a transition is characterized by the occurrence of an actual state and is denoted by the arrows going from one state to another state while the four prediction states are indicated by circles. (The actual states are denoted in italics while the four prediction states are underlined.)

For example, when the actual result or outcome is “not taken”, a state transition occurs from state 00 (strongly taken) to state 01 (taken) if the initial state was 00 (strongly taken). As a result, the prediction states will be influenced by the actual outcomes of a conditional branch instruction. It is to be understood that with an n-bit prediction scheme, the number of possible prediction states will equal the value 2ⁿ. For example, there are four prediction states when n=2. Of course, the number of prediction states (and the number of bits used to implement the prediction scheme) may vary depending on a particular implementation.

Because the actual results are used to correct or update the prediction states, a conditional branch instruction that is encountered in the future will utilize the updated prediction states. The use of such predictive schemes, as described in FIGS. 1A and 1B, usually improve performance in the execution of instructions of a program.

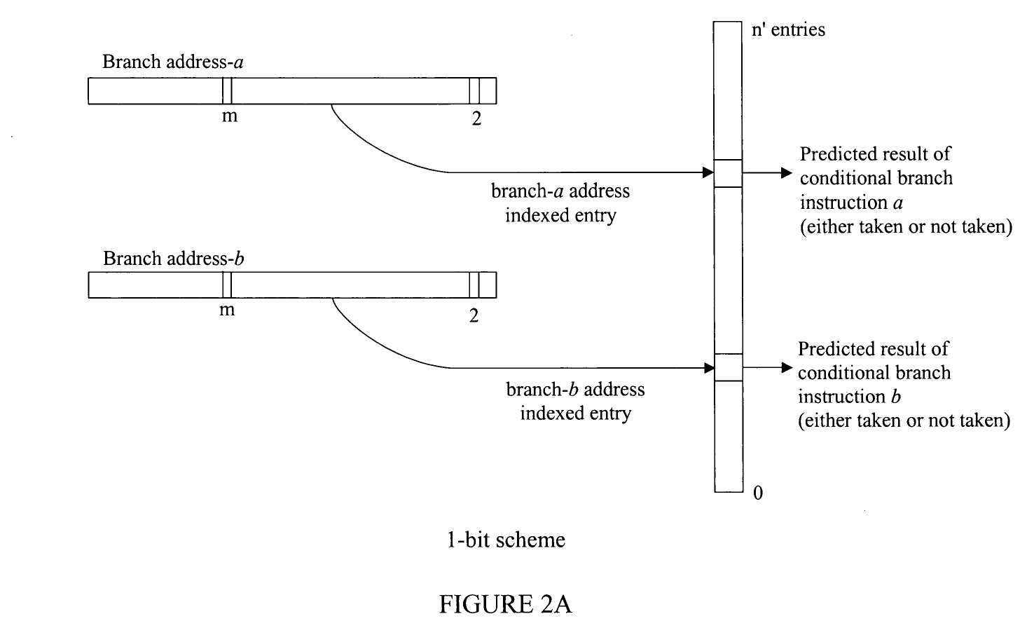

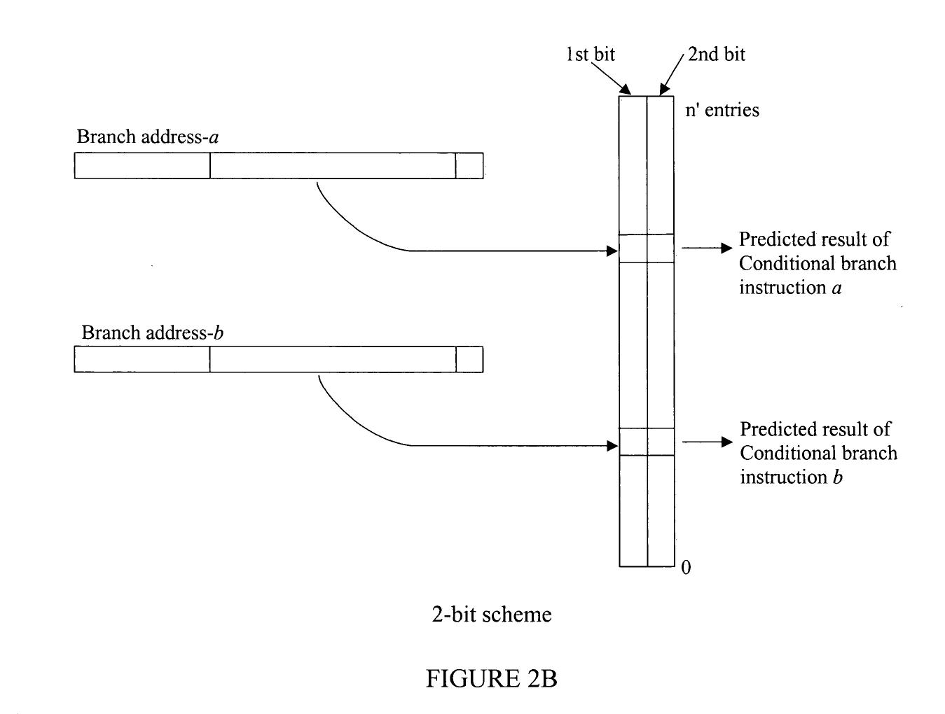

FIG. 2A illustrates a relational block diagram of an address of a conditional branch instruction being mapped to a one-bit branch history table (BHT). As shown, a portion or subset of a branch address is mapped to a storage device that implements a BHT. The storage device may comprise a memory such as a random access memory, for example. In reference to FIG. 2A, branch address-a corresponds to a branch address associated with conditional branch instruction-a while branch address-b corresponds to a branch address associated with conditional branch instruction-b. In this embodiment, a specific entry of the BHT is indexed by way of bits [m:2] for either branch address (i.e, branch address-a or branch address-b). The bits [m:2] for each branch address index a total of n′ entries in the BHT, where n′=2^{m-2}. As shown, the addresses for branch address-a or branch address-b each index one entry within the one-bit BHT. Each indexed entry provides a one-bit prediction result based on the prediction states previously described in the state transition diagram of FIG. 1A. For example, the branch address for conditional branch instruction-a (i.e., branch address-a) indexes an entry in the BHT corresponding to the predicted result of conditional branch instruction a. The indexed entry may provide either a 0 (taken) or 1 (not taken) outcome. Likewise, branch address-b indexes an entry in the BHT corresponding to predicted result of conditional branch instruction b.

FIG. 2B illustrates a relational block diagram of an address of a conditional branch instruction being mapped to a two-bit branch history table (BHT) in accordance with an embodiment of the invention. Similar to that shown in FIG. 2A, a portion or subset of a branch address is mapped to a storage device that implements a BHT. The storage device may comprise a memory such as a random access memory. In this embodiment, the BHT comprises n′ entries, in which each entry comprises two bits. Each indexed entry is mapped to two one-bit arrays to yield a two-bit prediction state that is used to provide a predicted result. For example, branch address-a indexes an entry in the BHT corresponding to the predicted result of conditional branch instruction-a. Conditional branch instruction-a may index one of four prediction states previously described in FIG. 1B. Likewise, branch address-b indexes an entry in the BHT corresponding to predicted result of conditional branch instruction-b.

In a number of circumstances, there are advantages associated with the use of more than a single bit in a conditional branch instruction predictive scheme. This may occur, for example, when two conditional branch instructions map to the same entry, such that 1) one of the instructions is executed at a higher frequency than the other instruction, and 2) the instruction that is executed at a higher frequency generates a particular outcome more frequently than the other possible outcomes; in one instance, for example, the executed instruction results in an outcome that is always taken.

In another instance, a conditional branch instruction maps to an entry that usually generates the same outcome. Typically, the second bit provides a more significant effect in a two-bit predictive scheme when an outcome of a conditional branch instruction is unstable. However, in most instances, the outcomes of conditional branch instructions are usually very stable and predictable. Although it is found that the performance of a two-bit predictive scheme is slightly better than that provided by a one-bit predictive scheme, the performance improvement may not justify the cost of implementing the second bit. As a consequence, aspects of the present invention provide for a method and system to implement a two-bit scheme utilizing a fraction of the usual memory space typically used to implement the BHT of the second bit.

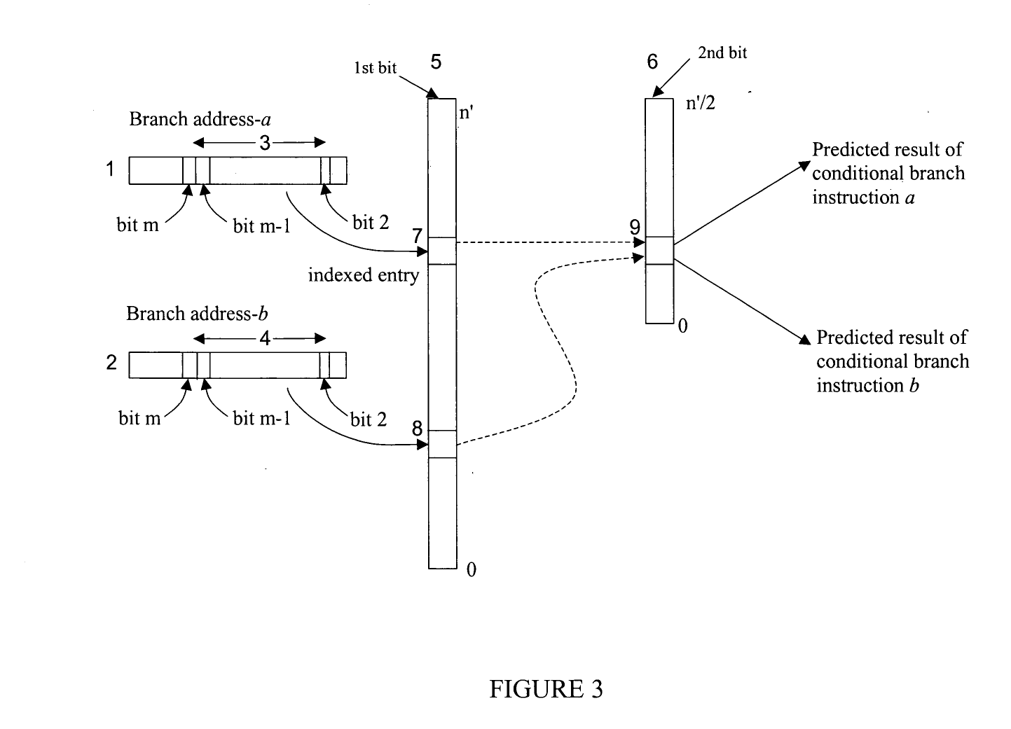

FIG. 3 illustrates a relational block diagram of an n′ entry BHT comprising two bit arrays 5, 6 of which the second bit array 6 is one half the size of the first bit array 5 in accordance with an embodiment of the invention. In this embodiment, the first bit array 5 contains n′=2^{m-2} entries while the second bit array 6 contains n′/2 (half as many) entries. As illustrated, conditional branch instruction addresses 1, 2, are used to index entries in a two-bit BHT. As shown, the BHT comprises two one bit arrays. The first bit array 5 of the BHT is mapped using bits [m:2] 3, 4 of the branch addresses 1, 2 associated with the two conditional branch instructions, a and b. For example, bits [m:2] 3 of the two addresses 1, 2 are used to index the first bit array 5. In this example, branch address-a 1 indexes a first indexed entry 7 of the first bit array 5 while branch address-b 2 indexes a second indexed entry 8 of the first bit array 5.

Likewise, the second bit array 6 is mapped using bits [m−1:2] of the branch addresses 1, 2 associated with their respective conditional branch instructions. In this example, the bits [m−1:2] associated with branch addresses 1, 2 of each branch instruction map to the same indexed entry 9 in the second bit array 6. However, the value for bit m may differ, for example, facilitating the mapping of two different indexed entries (indicated by reference numbers 7, 8) in the first bit array 5 previously described. For example, if the values for indexed entries 7, 8, 9 are 0, 1, 0, respectively, then the predicted result of instruction a (0,0) is taken while the predicted result of instruction b (1,0) is not taken. The embodiment illustrates how the addresses 1,2 associated with two different conditional branch instructions may share the same entry in the second bit array 6. As a result, the memory size of a bit array may be reduced based on the number of entries addressed. In this embodiment, the second bit array is configured to be one-half the size of the first bit array.

By sharing one or more entries of a bit array, it is possible to further reduce the memory size requirements in a two-bit predictive scheme. For example, if the second bit array 6 is mapped using bits [m−2:2] of the [m:2] bits used in addressing the two-bit BHT shown in FIG. 3, a further reduction in memory size may be attained. In this instance, the second bit array may be reduced to one-quarter of its previous memory size by appropriately configuring the mapping of addresses of conditional branch instructions. This is accomplished by sharing each entry in the second bit array 6 with multiple entries in the first bit array. Likewise, if the second bit array 6 is mapped using bits [m−3:2] of each conditional branch instruction address, the second bit array may be reduced to one-eighth of its previous size. Therefore, a reduction in BHT memory size may be attained by mapping a branch instruction address to a smaller number of entries in a bit array of a BHT. The memory used for implementing the bit arrays may comprise one or more random access memories, of which, a reduction in size may yield a significant cost savings to a manufacturer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of predicting the next state of one or more conditional branch instructions comprising mapping an address of a first conditional branch instruction and an address of a second conditional branch instruction to a same entry of a bit array in a branch history table.

2. The method of claim 1 wherein said branch history table comprises two one bit arrays used in a two-bit prediction scheme.

3. A method of predicting the next state of a conditional branch instruction comprising indexing a branch history table comprising a first bit array and a second bit array, said second bit array containing a fraction of the number of entries of said first bit array.

4. The method of claim 3 wherein said fraction comprises one half.

5. The method of claim 3 wherein said fraction comprises one quarter.

6. The method of claim 3 wherein said fraction comprises one eighth.

7. The method of claim 3 wherein said branch history table comprises a random access memory.

8. A method of predicting the next state of a conditional branch instruction comprising mapping a second bit array using a subset of bits used for mapping a first bit array.

9. The method of claim 8 wherein said bits used for mapping said first bit array exceeds said subset of bits used for mapping said second bit array by one.

10. The method of claim 8 wherein said bits used for mapping said first bit array exceeds said subset of bits used for mapping said second bit array by two.

11. The method of claim 8 wherein said bits used for mapping said first bit array exceeds said subset of bits used for mapping said second bit array by three.

12. The method of claim 8 wherein said next state comprises:
a strongly taken branch;
a taken branch;
a not taken branch; and
a strongly not taken branch.

13. A system for predicting the next state of a conditional branch instruction comprising:
a first bit array; and
a second bit array containing a fraction of a number of entries contained in said first bit array.

14. A system for predicting the next state of a conditional branch instruction comprising:
a branch history table comprising a first bit array containing a number of entries and a second bit array containing a fraction of said number of entries;
a number of bits of a first branch instruction address used to map said first bit array; and
a subset of said number of bits of a second branch instruction address used to map said second bit array of said branch history table.

15. The system of claim 14 wherein said fraction of said number of entries is one half of said number of entries.

16. The system of claim 14 wherein said fraction of said number of entries is one quarter of said number of entries.

17. The system of claim 14 wherein said fraction of said number of entries is one eighth of said number of entries.
